(19) United States
(12) Patent Application Publication
(10) Pub. No.: US 2020/0132877 A1
(43) Pub. Date: Apr. 30, 2020

(54) X-ray security inspection system

(71) Applicant: Jiabin Dong, Yuyao City (CN)

(72) Inventor: Jiabin Dong, Yuyao City (CN)

(21) Appl. No.: 16/729,492

(22) Filed: Dec. 30, 2019

(30) Foreign Application Priority Data
Oct. 29, 2019 (CN) 2019110380673

(51) Int. Cl. G01V 5/00; G01N 23/04

(52) U.S. Cl. CPC G01V 5/0008; B65G 43/02; G01N 23/04

(57) ABSTRACT

The invention discloses an X-ray security inspection system, which includes a fixing plate, an annular first electric guide rail is fixed on an end surface of the fixed plate, and an annular conveyor belt is installed on the upper side of the first electric guide rail, and the first electric guide rail is provided. After the startup, the conveyor belt is driven to rotate. A security inspection machine is fixed on the fixed plate. The conveyor belt passes through the security inspection machine. A circular fence is provided on the outer side of the conveyor belt. There is an isolation mechanism. Each compartment can only enter one person at a time. People move together with the isolation mechanism. After the luggage security check is completed, passengers take the luggage away and exit from the exit. This avoids the problem of crowded people and overlapping luggage.

### CROSS-REFERENCE TO RELATED APPLICATIONS

The present application claims priority from Chinese application No. 2019110380673 filed on Oct. 29, 2019 which is hereby incorporated by reference in its entirety.

### FIELD OF TECHNOLOGY

The invention relates to the technical field of security inspection, and in particular relates to a X-ray security inspection system.

### TECHNICAL FIELD

Security inspection machine, also known as security inspection instrument, is widely used in airports, railway stations, subway stations and other places with dense crowds. Security inspection machines rely on X-rays to detect luggage items. You can learn the contents of luggage without opening the luggage. The security inspection machine is generally a rectangular device with a rectangular conveyor belt. Passengers place their luggage on one end of the conveyor belt and then take it away from the other end of the conveyor belt. When there is a large flow of people, sometimes people will stack their luggage and cause inspection. The effect is poor, and the wrong items are often taken. At the same time, some luggage items will leave dust and impurities on the conveyor belt, which will contaminate the luggage of other passengers. In order to solve the above problems, the present invention is proposed.

### CONTENT OF THE INVENTION

The technical problem to be solved by the present invention is to provide an X-ray security inspection system, which overcomes the aforementioned problems.

The present invention is achieved by the following technical solutions.

An X-ray security inspection system includes a fixing plate, an annular first electric guide rail is fixedly fixed on an end surface of the fixed plate, an annular conveyor belt is installed on the upper side of the first electric guide rail, and the first electric guide rail is driven to drive The conveyor belt rotates, and a security inspection machine is fixed on the fixed plate. The conveyor belt passes through the security inspection machine. An annular fence is formed on the outside of the conveyor belt, and the fence forms a shunt cavity. The conveyor belt is located on the shunt. In the cavity, an isolation mechanism for avoiding congestion is provided in the shunting cavity, and the isolation mechanism includes a partition plate provided in the branching cavity and slidable along the inner wall of the fence, between each two of the partition plates. A partition is formed and an intermediate plate is fixedly connected between the partitions. The intermediate plate is provided with an entrance, the fence is provided with an entrance passage for people to enter, and the upper end surface of the conveyor belt is provided with a placement mechanism. Corresponding to a placement mechanism, a passenger enters from the entry channel, and after entering the compartment through the entrance, the luggage is placed on the placement mechanism, and the partition and the conveyor belt are counterclockwise. Rotating, passengers follow the rotation to avoid congestion. Security is checked when luggage passes through the security machine. There is an exit channel in the fence. Passengers take the luggage after security check and leave through the exit channel. After the luggage, it can be automatically cleaned to avoid contamination of the next luggage by the dust and impurities left by the luggage.

Further, the placement mechanism includes a housing fixedly disposed on the conveyor belt, the housing is provided with an upwardly-opening mounting cavity, and a rear side wall of the mounting cavity is fixed with a power motor, and the front side of the power motor A power shaft is connected to the power. A mounting shaft is rotatably provided on the rear wall of the mounting cavity. A belt pulley is fixed on the mounting shaft and the power shaft. The belt pulleys are connected by a belt drive. In the cleaning device, the passenger places the luggage on the belt, and after the security is removed, the power motor is started to rotate the belt through the cleaning device for cleaning.

Further, the cleaning device includes a scraping cavity, a cleaning cavity, and a drying cavity provided in the casing, the scraping cavity, the cleaning cavity, and the drying cavity are sequentially arranged from left to right, and the scraping The cavity, the cleaning cavity, and the drying cavity all open upward to communicate with the installation cavity. A scraping plate is fixed in the scraping cavity, and the upper end of the scraping plate is in contact with the belt. A dust collecting barrel is placed in the removal chamber, a rotary motor is fixed on the rear wall of the cleaning chamber, a rotary shaft is dynamically connected to the front side of the rotary motor, a brush is fixed on the rotary shaft, and the left wall of the cleaning chamber A nozzle is fixedly installed, the nozzle can spray water on the brush, a drainage hole is provided in the bottom wall of the cleaning chamber, and a fan for drying the belt is provided in the drying chamber.

Further, a support plate is fixed on the rear wall of the installation cavity, and a sensor is fixed on an end surface of the support plate. The belt is in contact with the sensor, and the sensor can detect whether luggage is placed on the belt. When the luggage is removed, the sensor sends a signal to start the power motor and the cleaning device.

Further, a circular electric guide rail is fixed on the fence, and the intermediate plate is mounted on the circular electric guide rail. After the circular electric guide rail is started, the intermediate plate is rotated to rotate the partition plate.

Further, the intermediate plate is a transparent material, and passengers can observe whether there is anyone in the compartment through the intermediate plate.

The beneficial effects of the present invention: The transmission in the local security inspection machine is set in a ring and is provided with an isolation mechanism. Each compartment can only enter one person at a time. The person moves along with the isolation mechanism. When the luggage security check is completed, the passenger takes the luggage And exit from the exit, avoiding the problem of crowded people and overlapping luggage, and avoiding the situation of taking the wrong luggage, and the conveyor belt that has been placed on the luggage will automatically clean it, avoiding dust and impurities left on it Baggage for the next passenger.

### BRIEF DESCRIPTION OF THE DRAWINGS

In order to more clearly explain the embodiments of the invention or the technical solutions in the prior art, the drawings used in the description of the embodiments or the prior art are briefly introduced below. Obviously, the drawings in the following description are merely For some embodiments of the invention, for those skilled in the art, other drawings can be obtained based on these drawings without paying creative labor.

FIG. 1 is a schematic diagram of the overall structure of the present invention;

FIG. 2 is a schematic structural diagram at A-A in FIG. 1;

FIG. 3 is a schematic structural diagram of a placement mechanism in FIG. 2;

FIG. 4 is a schematic structural view at B-B in FIG. 3.

### DETAILED DESCRIPTION OF THE INVENTION

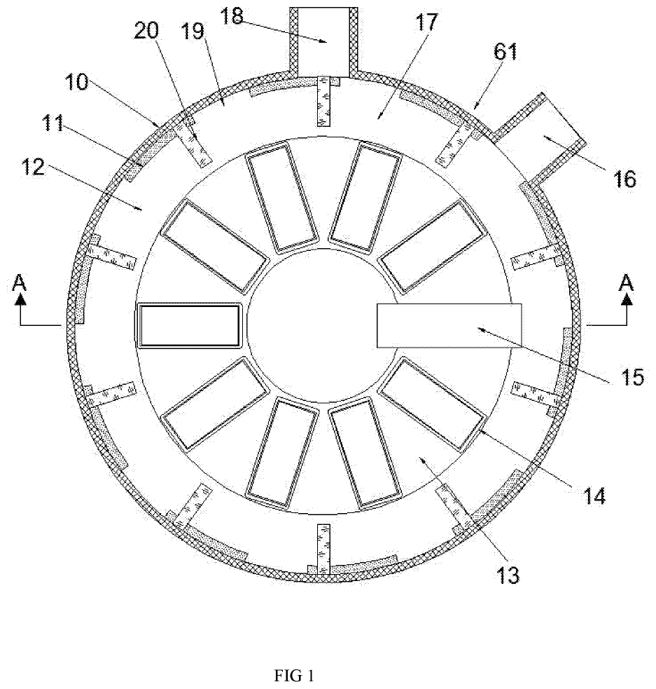

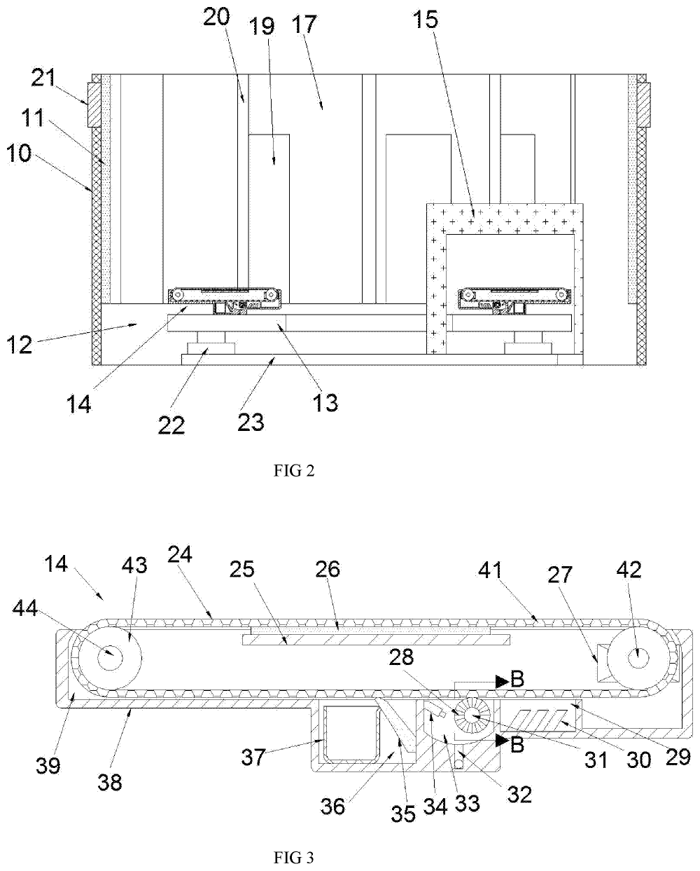

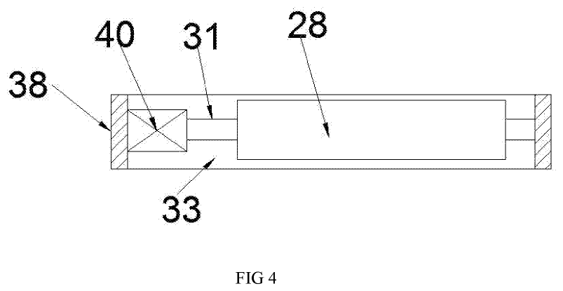

The present invention is described in detail below with reference to FIGS. 1-4. For convenience of description, the orientation described below is defined as follows: the up-down, left-right, front-back direction described below is consistent with the up-down left-right, front-back direction of the projection relationship of FIG.

An X-ray security inspection system described with reference to FIGS. 1-4 mainly includes a fixing plate 23, and an annular first electric guide rail 22 is fixed on an upper end surface of the fixed plate 23, and an upper side of the first electric guide rail 22 is installed. An endless conveyor belt 13 that drives the conveyor belt 13 to rotate after the first electric guide rail 22 is activated. A security inspection machine 15 is fixed on the fixing plate 23, the conveyor belt 13 passes through the security inspection machine 15, and the conveyor belt 13 A ring-shaped fence 10 is formed on the outer side, a shunt cavity 12 is formed in the fence 10, the conveyor belt 13 is located in the shunt cavity 12, and an isolation mechanism 61 for avoiding congestion is provided in the shunt cavity 12, and the isolation mechanism 61 includes a partition plate 20 provided in the shunt cavity 12 and slidable along the inner wall of the fence 10, a compartment 17 is formed between each two partition plates 20, and an intermediate plate 11 is fixedly connected between the partition plates 20, The middle plate 11 is provided with an entrance 19, the fence 10 is provided with an entrance passage 18 for people to enter, and the conveyor 13 has an upper end surface provided with a placement mechanism 14, each of the compartments 17 corresponds to a placement mechanism 14, and passengers Enter from the access channel 18 through the entrance 19 After entering the compartment 17, the luggage is placed on the placement mechanism 14. The partition 20 and the conveyor belt 13 rotate counterclockwise, and the passengers follow the rotation to avoid congestion. The luggage is carried through the security inspection machine 15 For security check, an exit channel 16 is provided in the fence 10. Passengers take the luggage after security check and leave through the exit channel 16. After the luggage is placed on the placement mechanism 14, it can be automatically cleaned to avoid dust and impurities left by the luggage. Contaminate the next bag.

Beneficially, the placing mechanism 14 includes a housing 38 fixedly disposed on the conveyor belt 13. The housing 38 is provided with a mounting cavity 39 which is opened upward, and a power motor 27 is fixed on the rear wall of the mounting cavity 39. A power shaft 42 is dynamically connected to the front side of the power motor 27. A mounting shaft 44 is rotatably provided on the rear wall of the mounting cavity 39, and a pulley 43 is fixed on the mounting shaft 44 and the power shaft 42. The pulley 43 is driven by a belt 24, and a cleaning device 60 is provided in the casing 38. Passengers place luggage on the belt 24. After the luggage is removed after the security check, the power motor 27 starts to make the belt 24 It is rotated through the cleaning device 60 for cleaning.

Advantageously, the cleaning device 60 includes a scraping cavity 36, a washing cavity 33, and a drying cavity 29 provided in the housing 38, and the scraping cavity 36, the washing cavity 33, and the drying cavity 29 are from left to The scraping cavity 36, the cleaning cavity 33, and the drying cavity 29 are opened in an orderly communication with the mounting cavity 39, and a scraping plate 35 is fixed in the scraping cavity 36. The upper end of the scraping plate 35 is in contact with the belt 24, a dust collecting bucket 37 is placed in the scraping cavity 36, a rotary motor 40 is fixed on the rear wall of the cleaning cavity 33, and the front side of the rotary motor 40 is dynamically connected There is a rotating shaft 31, a brush 28 is fixed on the rotating shaft 31, and a nozzle 34 is fixed on the left wall of the cleaning chamber 33. The nozzle 34 can spray water on the brush 28, and the cleaning chamber A drainage hole 32 is provided in the bottom wall 33, and a fan 30 for drying the belt 24 is provided in the drying cavity 29.

Advantageously, a support plate 25 is fixed on the rear wall of the mounting cavity 39, and a sensor 26 is fixed on the upper end surface of the support plate 25. The belt 24 is in contact with the sensor 26, and the sensor 26 can detect when the Whether luggage is placed on the belt 24. When the luggage is removed, the sensor 26 sends a signal to activate the power motor 27 and the cleaning device 60.

Advantageously, a circular electric guide rail 21 is fixed on the fence 10, and the intermediate plate 11 is mounted on the circular electric guide rail 21. After the circular electric guide rail 21 is started, the intermediate plate 11 is rotated to make all The partition plate 20 rotates.

Beneficially, the intermediate plate 11 is a transparent material, and passengers can observe whether there are people in the compartment 17 through the intermediate plate 11.

The sequence of mechanical actions of the entire device:

1. Start the ring-shaped electric guide rail 21 to rotate the intermediate plate 11, and the intermediate plate 11 drives the partition plate 20 to rotate counterclockwise;

2. Start the first electric guide rail 22 to rotate the conveyor belt 13 counterclockwise;

3. Passengers enter from the entry aisle 18 and enter the compartments 17 through the entrance 19, each compartment 17 accommodating one passenger;

4. After the passenger enters the compartment 17, the luggage items are placed on the belt 24, and the sensor 26 detects that the items are placed on the belt 24;

5. The passenger moves synchronously with the conveyor belt 13 and performs security inspection when the placement mechanism 14 with luggage is entered into the security inspection machine 15;

6. The passenger removes the checked luggage from the belt 24 and then exits the exit passage 16;

7. The power motor 27 in the placement mechanism 14 where the luggage has been placed is started to rotate the belt 24. When the belt 24 passes through the scraping chamber 36, the dust and other impurities on the belt 24 are scraped off by the scraping plate 35, and the dust and impurities Into the dust collecting bucket 37;

8. The nozzle 34 is activated to spray water on the brush 28, and the rotary motor 40 is started to rotate the brush 28 through the rotation shaft 31. When the belt 24 passes through the cleaning chamber 33, the brush 28 brushes the belt 24;

9. The fan 30 starts to blow out hot air. When the brushed belt 24 passes the upper side of the drying cavity 29, it is dried by the hot air. After the cleaned belt 24 rotates to the initial position, the power motor 27 is turned off.

The above embodiments are only for explaining the technical concept and characteristics of the present invention, and the purpose thereof is to enable those skilled in the art to understand and implement the content of the present invention, but not to limit the protection scope of the present invention. Any equivalent change or modification made according to the spirit and essence of the present invention should be covered by the protection scope of the present invention.

1. An X-ray security inspection system includes a fixing plate, characterized in that:
an end surface of the fixing plate is fixedly provided with a ring-shaped first electric guide rail, and an upper side of the first electric guide rail is provided with an endless conveyor belt, and the first electric guide rail After the startup, the conveyor belt is driven to rotate. A security machine is fixed on the fixed plate. The conveyor belt passes through the security machine. An annular fence is provided on the outside of the conveyor belt. The fence forms a shunt cavity. The conveyor belt Located in the shunt cavity, an isolation mechanism for avoiding congestion is provided in the shunt cavity, and the isolation mechanism includes a partition plate disposed in the shunt cavity and slidable along the inner wall of the fence. A partition is formed between the partitions, and an intermediate plate is fixedly connected between the partitions. The intermediate plate is provided with an entrance, the fence is provided with an access channel for people to enter, and the upper end surface of the conveyor belt is provided with a placement mechanism. The compartment corresponds to a placement mechanism. Passengers enter from the immersion channel, and after entering the compartment through the entrance, the luggage is placed on the placement mechanism. The partition, the The conveyor belt rotates counterclockwise, and the passengers follow the rotation to avoid congestion. The baggage passes through the security screening machine for security check. There is an exit passage in the fence. The passenger takes the luggage after security check and exits through the exit passage. The placement mechanism After the luggage has been placed on it, it can be automatically cleaned to prevent the dust and impurities left by the luggage from contaminating the next luggage.

2. The X-ray security inspection system according to claim 1, wherein the placement mechanism comprises a casing fixedly disposed on the conveyor belt, and the casing is provided with an upwardly-opening mounting cavity, and the mounting A power motor is fixed on the back wall of the cavity, and a power shaft is dynamically connected to the front side of the power motor. A mounting shaft is rotatably provided on the back wall of the mounting cavity, and a pulley is fixed on the mounting shaft and the power shaft. The belt pulleys are connected by a belt drive. The housing is provided with a cleaning device. Passengers place luggage on the belt. After the luggage is removed after the security check, the power motor starts to rotate the belt through the cleaning device to clean.

3. The X-ray security inspection system according to claim 2, wherein the cleaning device comprises a scraping cavity, a cleaning cavity, and a drying cavity provided in the casing, and the scraping cavity and the cleaning cavity The drying chamber is arranged in order from left to right. The scraping chamber, the cleaning chamber, and the drying chamber all open upwardly to communicate with the installation chamber. A scraping plate is fixed in the scraping chamber. The upper end of the scraping board is in contact with the belt, a dust collecting bucket is placed in the scraping chamber, a rotary motor is fixed on the rear wall of the cleaning chamber, and a rotary shaft is connected to the front side of the rotary motor. A brush is fixed on the rotating shaft, and a nozzle is fixed on the left wall of the cleaning chamber, the nozzle can spray water on the brush, a drainage hole is provided in the bottom wall of the cleaning chamber, and the drying chamber There is a fan for drying the belt.

4. The X-ray security inspection system according to claim 3, wherein a support plate is fixed on the rear wall of the mounting cavity, a sensor is fixed on an end surface of the support plate, and the belt is in contact with the sensor. The sensor can detect whether there is luggage on the belt, and when the luggage is removed, the sensor sends a signal to start the power motor and the cleaning device.

5. The X-ray security inspection system according to claim 1, characterized in that: a circular electric guide rail is fixed on the fence, the intermediate plate is installed on the circular electric guide rail, and the circular electric guide rail is activated after being activated. The intermediate plate rotates, thereby rotating the partition.

6. The X-ray security inspection system according to claim 1, wherein the intermediate plate is a transparent material, and passengers can observe whether there are people in the compartment through the intermediate plate.
